(19) United States
(12) Patent Application Publication
(10) Pub. No.: US 2010/0163075 A1
(43) Pub. Date: Jul. 1, 2010

(54) METHOD FOR THERMAL DEBURRING

(76) Inventors: Guenther Kuehdorf, Vaihingen-Enz (DE); Hans-Juergen Conrad, Griolzheim (DE); Max Seitter, Muehlacker (DE)

Correspondence Address: MICHAEL J. STRIKER, 103 EAST NECK ROAD, HUNTINGTON, NY, 11743, US

(21) Appl. No.: 12/161,116

(22) PCT Filed: Dec. 20, 2006
(86) PCT No.: PCT/DE2006/002284

§ 371 Date: Mar. 18, 2010

(30) Foreign Application Priority Data
Jan. 25, 2006 (DE) 10 2006 003 451.1

(51) Int. Cl. B08B 7/00

(52) U.S. Cl. 134/19

(57) ABSTRACT

In the thermal deburring of work pieces, sensitive surfaces are provided with a removable surface protection.

The invention relates to a method for thermal deburring of work pieces as recited in the preamble to claim 1.

A method of this kind is known, for example, from DE 35 04 447 A1. The work pieces in said method are deburred in a closable deburring chamber by igniting a process gas filling that is introduced into the deburring chamber. The process gas can, for example, be an ignitable methane/oxygen mixture. When it is ignited, temperatures of up to 3500° C. and pressures of up to 1000 bar are achieved for an interval of a few milliseconds. Burrs on work pieces are characterized by a very small volume relative to their surface area. Consequently, the explosion heats them so powerfully that they are burned away. The solid work piece, however, is heated only slightly, for example to 150° C.

The known method has the disadvantage that it is only suitable for work pieces that have a sufficiently high resistance to brief exposure to heat and pressure. Work pieces that have already been provided with coatings or installed parts made of plastic before a material-removing machining, for example, cannot be deburred using this method because the plastic would be thermally destroyed.

The object of the invention, therefore, is to disclose a method that can be used to thermally deburr work pieces with thermally sensitive surface sections. This object is attained by means of the defining characteristics of claim 1.

During the deburring, the sensitive surface sections have a surface protection that can be removed again afterward. On the one hand, the surface protection should keep the explosion heat away from the underlying sensitive surfaces as much as possible and on the other hand, should be easy to remove again, leaving no residue.

This problem can be solved in that the surface protection is composed of a frozen fluid that covers the sensitive surfaces. For example, the fluid can be water or carbon dioxide, i.e. a fluid that is liquid or gaseous at room temperature or at higher temperatures that do not damage the sensitive surfaces of the work piece. The explosion heat is then no longer able to penetrate to the sensitive surfaces because it must first melt the frozen fluid. Due to the short heat exposure time, however, this cannot happen if the protective layer is of a sufficient thickness. The thickness of the protective layer is chiefly determined by the melting heat required for the phase change from solid to fluid. This energy quantity must be guaranteed to be greater than the energy that the explosion transmits to the protective layer. The phase change of the fluid also prevents the explosion heat from being able to reach the sensitive surfaces through thermal conduction because the frozen fluid cannot have a higher temperature than the melting temperature as it melts. In the present instance, it is necessary to take into account the dependency of the melting temperature on the rapidly changing pressure.

The protective layer and its residues can be easily removed again by thawing them at room temperature. Depending on the fluid used, it can also be necessary to heat the work piece to the melting point of the fluid. If water is used as the fluid, then the formation of scale flakes on the work piece upon evaporation of the water can be prevented by using demineralized water.

The protective layer in the form of the frozen fluid can be applied to the work piece by placing the fluid in a liquid or gaseous state against the surface of the work piece and then freezing it there. This can occur, for example, by virtue of the fact that the work piece is first cooled to below the melting point of the fluid. The fluid, which is then poured over the surfaces to be protected, solidifies as soon as it comes into contact with the cold work piece. In this case, the work piece must be continuously cooled in order to dissipate the released solidification heat.

It is also conceivable, however, to use a fluid in the form of a gel or paste. It is thus possible for the fluid to be spread onto the work piece at room temperature. The fluid can then be converted to the solid state through local application of cold, e.g. with cold spray or through the cooling of the work piece in a cooling chamber.

A disadvantage of the above-describe methods is that they are relatively slow and are too expensive for mass production. Consequently, the invention proposes using a surface protection in the form of a separate component that is attached to the work piece. The separate component can once again be embodied in the form of a frozen fluid, for example in the form of an ice rivet. The separate component is preferably attached to the work piece in a form-locked fashion in order to reduce costs. For example, it is conceivable to protect a bore with an adapted ice rivet, which is inserted into it in a form-locked fashion. The ice rivet in the form of a stepped cylinder can be mass-produced in advance and is therefore inexpensive to manufacture.

It is also conceivable, however, to produce the separate component of a solid nonmetal. Nonmetals usually have a low thermal conductivity. The explosion heat is therefore unable to penetrate the separate component during the short exposure time. The material can, for example, be plastic or wood—preferably in the form of particleboard components. These materials, however, have the disadvantage that the explosion during the deburring process damages or totally destroys them. For this reason, they can only be used once. Because of the low manufacturing costs of components of this kind, however, this does remain economically feasible. If a plastic is used for the separate component, then care must be taken that the explosion heat does not weld it to the work piece. From an entirely general standpoint, it is necessary to bear in mind with this embodiment that after the deburring process, the partially destroyed separate component can be easily removed without leaving any residue.

It is therefore possible for the separate component to be used several times as a surface protection. For example, one possible material for such a component is ceramic. It is distinguished by a low thermal conductivity and a high temperature resistance. A separate component produced from it is therefore not damaged by the explosion during the deburring process. Any remaining soiling due to the presence of combustion residues must be removed before the separate component is reused.

According to another embodiment, the surface protection can also be composed of a viscous compound. This can conceivably be wood shavings that are bonded with a bonding agent to form a viscous paste. This paste can, for example, be used to fill a bore. The viscosity must be selected to be high enough that the compound essentially remains in place even under the influence of explosion forces. At the same time, the viscosity must not be too high, so that the compound is easy to apply and is also easy to remove again.

The invention will be described in greater detail below in conjunction with the accompanying drawing.

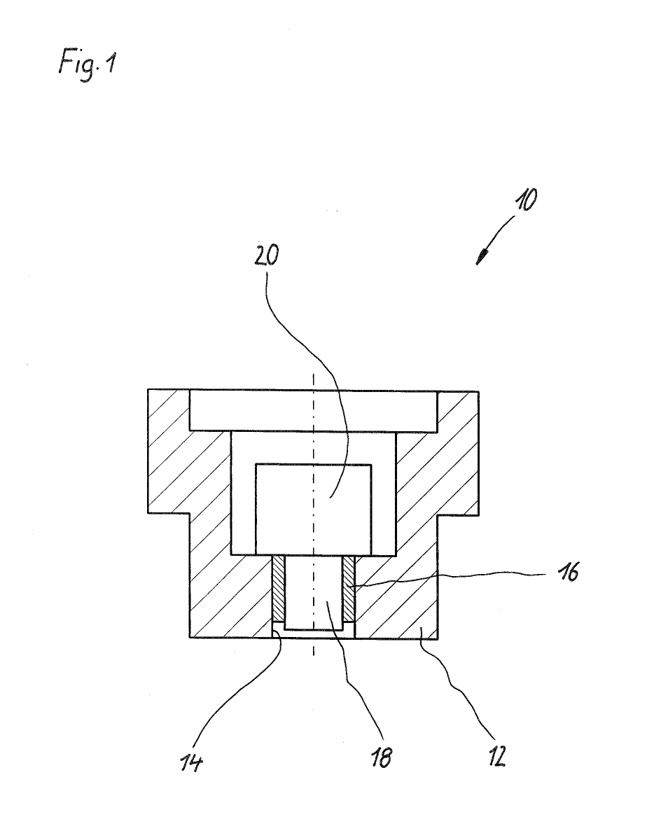

FIG. 1 shows a work piece with a surface protection according to the invention.

In FIG. 1, a work piece with a surface protection according to the invention is labeled as a whole with the reference numeral 10. This work piece is thermally deburred in the deburring apparatus according to DE 35 04 447 A1. To this end, it is inserted into the deburring chamber of this deburring apparatus. The deburring chamber is closed in a pressure-tight fashion and filled with a process gas in the form of a mixture of natural gas and oxygen. The process gas is then ignited, causing the burrs on the work piece to burn away.

The work piece 10 is a housing 12 composed of aluminum whose bore 14 has a bushing 16 inserted into it. This bushing provides a bearing support for a component, not shown, and is therefore provided with a friction-reducing plastic coating. The bushing 16 is inserted into the housing 12 before the housing is machined in a material-removing fashion by means of a lathe. During thermal deburring of the work piece 10, there is thus the danger that the plastic coating of the bushing 16 will be destroyed by the explosion heat.

In order to prevent this, the bushing is provided with a surface protection in the form of an ice rivet. The ice rivet is embodied in the form of a stepped cylinder. It is manufactured by pouring water into a corresponding negative mold and cooling it to below the freezing point of 0° C. The precisely fitting ice rivet is inserted into the bushing shortly before the deburring and is secured there in a form-locked fashion.

During the deburring, the explosion heat partially melts the ice rivet so that it can be removed from the bushing without expenditure of force once the work piece has been removed from the deburring chamber. Any water residue remaining on the work piece is removed by spraying with compressed air.

### REFERENCE NUMERAL LIST

10 work piece
12 housing
14 bore
16 bushing
18 surface protection

What is claimed is:

1. A method for thermal deburring of work pieces in a closable deburring chamber through the ignition of a combustible process gas filling introduced into the deburring chamber,
wherein sections of the work pieces are provided with a removable surface protection.

2. The method as recited in claim 1,
wherein the surface protection is composed of a frozen fluid, preferably water or carbon dioxide.

3. The method as recited in claim 2,
wherein the fluid is demineralized water.

4. The method as recited in claim 2,
wherein the frozen fluid is removed again by means of thawing.

5. The method as recited in claim 2, wherein the fluid is placed against the surface of the work piece in a liquid or gaseous state and frozen there.

6. The method as recited in claim 1, wherein the surface protection is a separate component that is attached to the work piece, preferably in a form-locked fashion.

7. The method as recited in claim 6,
wherein the separate component is composed of a solid nonmetal, preferably plastic, ceramic, or wood.

8. The method as recited in claim 7,
wherein the separate component is usable multiple times and is preferably composed of ceramic.

9. The method as recited in claim 1,
wherein the surface protection is composed of a viscous compound.
